(19) United States
(12) Patent Application Publication
(10) Pub. No.: US 2015/0064405 A1
(43) Pub. Date: Mar. 5, 2015

(54) LOW REFLECTIVITY ARTICLES AND METHODS THEREOF

(71) Applicant: CORNING INCORPORATED, Corning, NY (US)

(72) Inventors: Karl William Koch, III, Elmira, NY (US); Ellen Marie Kosik Williams, Painted Post, NY (US)

(73) Assignee: CORNING INCORPORATED, Corning, NY (US)

(21) Appl. No.: 14/057,638

(22) Filed: Oct. 18, 2013

Related U.S. Application Data
(60) Provisional application No. 61/872,043, filed on Aug. 30, 2013.

(51) Int. Cl. G02B 1/11

(52) U.S. Cl. CPC G02B 1/118; G02B 1/11
USPC 428/147; 427/162; 428/143; 428/149

(57) ABSTRACT

An anti-reflective article, including:
a substrate;
an integral binder region on at least a portion of the surface of the substrate; and
a nanoparticulate monolayer partially embedded in the integral binder region, as defined herein. The integral binder can be comprised of the same or different material as the substrate material. Methods of making and using the article are also disclosed.

### CROSS-REFERENCE TO RELATED APPLICATIONS

The entire disclosure of any publication or patent document mentioned herein is incorporated by reference.

This application claims the benefit of priority under 35 U.S.C. §119 of U.S. Provisional Application Ser. No. 61/872,043, filed Aug. 30, 2013, the content of which is relied upon and incorporated herein by reference in its entirety.

This present disclosure is related to commonly owned and assigned U.S. Ser. No. 13/440,183, filed Apr. 5, 2012, and published as US2012-0281292; U.S. Ser. No. 61/557,490 now U.S. Ser. No. 13/668,537, filed Nov. 5, 2012; U.S. P Ser. No. 61/731,924, filed Nov. 30, 2012; U.S. Ser. No. 13/090,561, filed Apr. 20, 2011; U.S. Ser. No. 13/662,789, filed Oct. 29, 2012; U.S. Ser. No. 13/900,659, filed May 23, 2013; and provisional patent application U.S. Ser. No. 61/872,037, filed Aug. 30, 2013, the entire disclosures of which are incorporated herein by reference, but do not claim priority thereto.

### BACKGROUND

The disclosure relates generally to a low-reflectivity surface or an anti-reflection (AR) surface, articles thereof, and methods of making and using the surface.

### SUMMARY

In embodiments, the disclosure provides a low-reflectivity coating having at least one layer comprising a monolayer of nanoparticles or a near-monolayer of nanoparticles.

In embodiments, the disclosure provides an article incorporating the low-reflectivity coating.

In embodiments, the disclosure provides a method of making the article that includes generating an integral or transient binder layer or binder region on a surface of a substrate, such as by localized heating or radiation; and depositing a nanoparticulate monolayer or near-monolayer on the integral binder.

In embodiments, the disclosure provides a method of using the article, for example, in a display device, which includes incorporating the disclosed article in a display device.

### BRIEF DESCRIPTION OF THE DRAWINGS

In embodiments of the disclosure:

FIGS. 1A and 1B respectively show a side view (1A) and a top view (1B) of an exemplary near monolayer AR coating having a non-close pack hexagonal arrangement.

FIG. 2 shows a series of simulated cross sections of minimal reflectivity structures for a series of relative binder levels having a binder region nanoparticle immersion depth (g) as a function of spherical or near spherical particle diameter (D).

FIGS. 3A to 3J show a series of graphs of the reflectivity in percent as a function of wavelength for a series of selected binder-level thicknesses (g) in terms of selected structural parameters.

FIGS. 4A to 4H show a series of graphs of contours of the averaged reflectivity, the spectral reflectivity averaged from 450 to 650 nm, and the reflectivity normalized by 200 nm to give the average reflectivity in percent.

FIGS. 5A to 5D show plots of preferred design parameters plotted against one another.

FIGS. 6A to 6D show the impact of variations in the particle density on optical haze.

FIG. 7 shows an example atomic-force microscope height image of an exemplary glass surface that was dip-coated to provide a particulated substrate surface having 120 nm silica spheres and without a separate binder layer, that is, free of a separate binder layer.

FIG. 8 shows measured data for specular reflectance % of a batch of samples over the wavelengths 300 to 800 nm using two different nanoscopic diameter silica spheres coated onto an ionically exchanged glass substrate.

FIG. 9 shows reflectance % data calculated using the effective index model (EIM) and is compared to the ion exchanged sample data mentioned in FIG. 8.

FIG. 10 shows a comparison between the EIM model results and the measured reflected spectrum of the sample shown in FIG. 7.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed article and the disclosed method of making and using the article provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### DEFINITIONS

“Antireflection” and like terms refer to a reduction in total reflection (specular and diffuse), which may be induced by the disclosed coating or surface treatment.

“Reflectivity” and like terms refer to, for example, the disclosed article having an average reflectivity of less than 0.1 to 0.2% over a spectral width of at least 100 nm covering at least a portion of the visible wavelength spectrum from 400 to 700 nm.

“Binder,” “binder region,” and like terms refer to a substrate surface material that can be used to join or strengthen the bonding between surfaces, such as between particles or between particles and a glass substrate surface.

“Integral binder,” “integral binder region,” and like terms refer to at least a portion of the substrate surface material that can be, for example, temporarily or transiently transformed from a non-adhesive or non-binding solid surface to an adhesive or binding viscous liquid surface that can be used to join or strengthen the bond between surfaces, such as between particles or between particles and a glass substrate surface. The integral binder preferably can be, for example, at least one time, reversibly transformed from the temporarily or transiently achieved particle adhesive or adherent surface, or binding viscous liquid surface to a non-adhesive or non-binding solid surface.

“Nanoparticulate monolayer” and like terms refer to a single layer of particles, typically in contact with a surface or substrate, where the particles have an average size or average diameter that is generally about 500 nm or less, and the majority of the particles have a size variation that is less than about plus or minus (+/−) 100%. The spacing between the particles is preferably substantially uniform, for example, a center-to-center spacing variation of less than about plus or minus (+/−) 50%

“Include,” “includes,” or like terms mean encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance, condition, or step, can or cannot occur, and that the description includes instances where the event or circumstance, condition, or step occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, and like aspects, and ranges thereof, are for illustration only; they do not exclude other defined values or other values within defined ranges. The apparatus and methods of the disclosure can include any value or any combination of the values, specific values, more specific values, and preferred values described herein, including explicit or implicit intermediate values and ranges.

In embodiments, the disclosure provides low-reflective or anti-reflective (AR) surfaces having a number of applications, especially in display devices, or whenever light encounters an interface between dissimilar materials (e.g., glass and air). The dissimilar interfaces can result in reflected light that, for many applications, is problematic. In many instances it is possible to apply films or textures to the surface to suppress or eliminate these reflections. However, approaches using, for example, vacuum-deposited thin films can be costly. Additionally, the tolerances on the film thicknesses to eliminate the reflections are difficult to achieve and control, especially for large-area coatings or complex structures.

Another approach to reducing reflections at interfaces is the use of surface texturing. Surface texturing can involve, for example, coating a surface with particles. The application of the particles to the surface can be accomplished, for example, with photolithography, although this approach is costly and difficult to perform on large-scale substrates. The adhesion of the particles to the surface can involve electro-static or van der Waal's forces, which can be poor, resulting in soft or easily damaged coatings. The damage resistance of particle-textured surfaces can be further improved by applying a protective coating layer over the particulated substrate surface.

In addition to reduced reflectivity, display devices and other devices involving interfaces involving light, may benefit from controlled optical scattering. Scattering at or near the interface can smear reflected images to reduce their interference with a display's transmitted image. By smearing the light out over a range of angles, the brightness of the reflection, the amount of reflected power per unit solid angle, can be reduced.

In embodiments, the disclosure provides surface treatments and surface structures that achieve low reflectivity over a wide spectral region. The disclosed surface treatment provides a nearly monodisperse coating of spherical particles associated with a layer of binding material applied to or created at the interface between the substrate and the particles. The surface treatments and surface structures rely on sub-wavelength particles, such as nanoparticles. The use of sub-wavelength particles produces a tolerance to fluctuations in the local density of particles, and permits a random process to be used for placing the particles on the surface, so long as the average particle density (p) of particles is, for example, from about 1 and 100/micronmeters², and preferably from about 5 and 55/micronmeters², including intermediate values and ranges. The application of particles can be accomplished with a low-cost, scalable process, for example, dip-coating, and like processes.

In embodiments, the disclosure provides articles having broadband, low-haze, and low-reflectivity properties obtained from random coatings of spherical particles on a substrate having an integral binder region or integral binder layer. The properties can be characterized by selected parameters, for example, average particle density (p), particle diameter (D), and integral binder layer or integral binder region thickness (g). The properties are at a local minimum in the parameter space, which results in an insensitivity of the reflectivity performance to small variations in the selected parameters. Additionally, the haze of the uniform integral binder coatings can be controlled by minimizing the area of the largest unparticulated regions, i.e., regions without spherical particles.

In embodiments, the disclosure provides methods for making the disclosed article, and methods of using the disclosed article in anti-reflective applications.

In embodiments, the disclosed article and methods are advantaged in several aspects. The disclosed method of making a low-reflectivity surface can be performed on large area substrates, in a scalable process, enabling a high-performance, low-cost result. The disclosed low-reflectivity surfaces and their articles have robust performance with respect to the type of manufacturing variations encountered in low-cost processes. The low-reflectivity performance persists over a large range of light incidence angles, and over a broad range of wavelengths.

In embodiments, the disclosure provides methods of making the articles having a series of binder levels, which enables one to select and achieve a desired level of toughness for a particular application. Because the particles are sub-wavelength in size variations in the local density, such as measured over areas on the order of a square wavelength (λ²) have little impact on the optical performance. This makes the process compatible with the random nature of, for example, dip coating, and like processes.

In embodiments, the disclosure provides an anti-reflective article, comprising: a substrate; an integral binder region on at least a portion of the surface of the substrate; and a nanoparticulate monolayer partially embedded in the integral binder region layer, wherein the ratio of the thickness of the integral binder region layer or particle immersion depth (g) to the thickness or diameter (D) of the nanoparticulate monolayer (g:D) can be, from about 1:50 to 3:5, from about 1:50 to 1:2, from 1:10 to 1:2, and including intermediate values and ranges.

In embodiments, the nanoparticulate monolayer are each independently selected from at least one of a glass, a polymer, a ceramic, a composite, and like materials, or a combination thereof.

In embodiments, the integral binder layer or integral binder region can be, for example, a surface region of the substrate having a thickness (t) of from 1 nm to 5,000 nm, and from 5 nm to 5,000 nm, including intermediate values and ranges, and the nanoparticulate monolayer comprises nanoparticles having an average diameter (D) of from 50 nm to about 300 nm.

In embodiments, the integral binder region layer compromises the surface of the substrate having nanoparticles partially submerged into the surface of the substrate at an immersion depth (g) of from 5 nm to about 150 nm, and the nanoparticulate monolayer comprises nanoparticles having an average diameter (D) of from 50 nm to about 300 nm.

In embodiments, the nanoparticles of the nanoparticulate monolayer comprise spheres of silica or like oxides or mixed oxides, having an average diameter (D) less than at least one wavelength of visible light.

In embodiments, the nanoparticulate monolayer has at least one, or alternatively a plurality of unparticulated voids or particle areas of at least from 0.1 to 1 square micron.

In embodiments, the disclosure provides a method of making the above described low reflectivity article, comprising:

applying a monolayer of nanoparticulates to the integral binder region of a surface of the substrate to provide a g:D ratio.

In embodiments, applying a monolayer of nanoparticulates to at least one surface of the substrate is accomplished by dip coating the substrate into a mixture of the integral binder and the nanoparticulates.

In embodiments, the integral binder region can be, for example, a portion of the surface of the substrate, and the nanoparticulate monolayer is partially embedded in the integral binder region or integral binder layer.

In embodiments, the method can further comprise transiently generating the integral binder region, for example, temporarily softening the surface of the substrate before applying the monolayer of nanoparticulates to the surface of the substrate, wherein the applied nanoparticulates partially sink into the surface of the transient integral binder region of the softened substrate.

In embodiments, the method of making can include or further comprise, for example, strengthening the substrate by ion-exchange before, after, or both before and after, applying the monolayer of nanoparticulates to the at least one transiently softened surface of surface of the substrate (i.e., integral binder region or integral binder layer).

In embodiments, the disclosure provides low reflectivity surfaces comprised of one or more monolayers of sub-wavelength spherical silica particles attached to the substrate with, for example, an integral binder (i.e., the binder is comprised of the same material as the substrate), with an optional binder that is an extrinsic binder and is comprised of material that is the same or different from the substrate material, and combinations thereof.

“Consisting essentially of” or “consisting of” in embodiments can refer to, for example:

an article having a low-reflectivity surface as defined herein;

a method of making or using the low-reflectivity article as defined herein; or

a display system that incorporates the article, as defined herein.

The article, the display system, the method of making and using, compositions, formulations, or any apparatus of the disclosure, can include the components or steps listed in the claim, plus other components or steps that do not materially affect the basic and novel properties of the compositions, articles, apparatus, or methods of making and use of the disclosure, such as particular reactants, particular additives or ingredients, a particular agent, a particular surface modifier or condition, or like structure, material, or process variable selected. Items that may materially affect the basic properties of the components or steps of the disclosure or that may impart undesirable characteristics to the present disclosure include, for example, a surface having objectionable high reflectivity properties that are beyond the values, including intermediate values and ranges, defined and specified herein.

The article, the method of making the article, and the method of using the article, of the disclosure can include the components or steps listed in the claim, plus other components or steps that do not materially affect the basic and novel properties of the compositions, articles, apparatus, or methods of making and use of the disclosure, such as a particular article configuration, particular additives or ingredients, a particular agent, a particular structural material or component, a particular irradiation, pressure, or temperature condition, or like structure, material, or process variable selected.

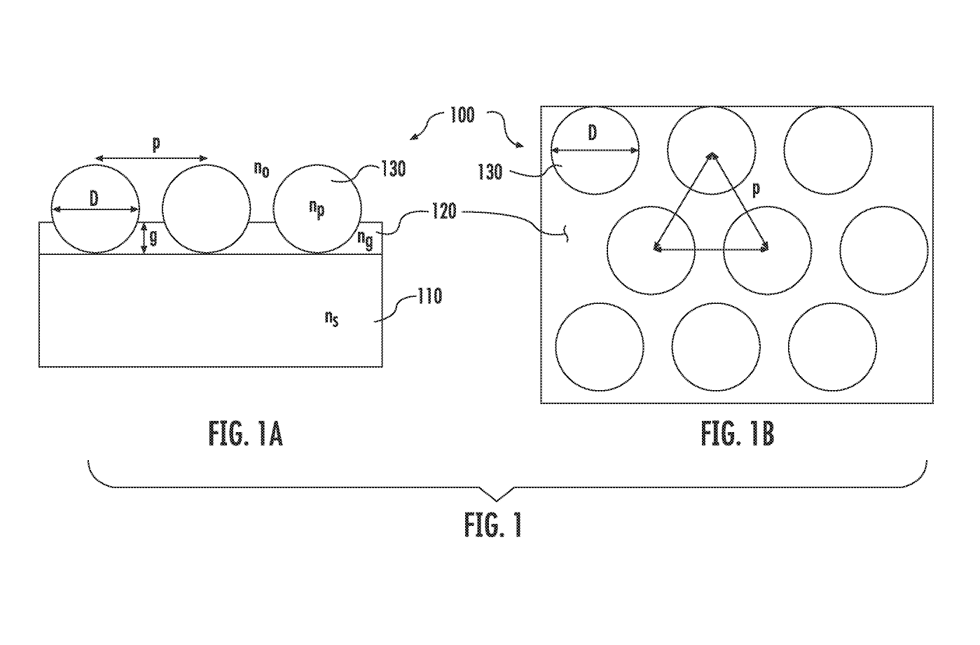

Referring to the Figures, FIGS. 1A and 1B respectively show an exemplary near monolayer AR coating having a non-close pack hexagonal arrangement; side view (1A); and top view (1B). FIG. 1A is a cross sectional representation of a preferred spherical particle diameter (D) for a given integral binder region or integral binder layer thicknesses, or equivalently, nanoparticulate sphere immersion or submersion level (g), to achieve minimum reflectivity, and where:

nₛ is the refractive index of the substrate(s);

n_{g} is the refractive index of the integral binder region;

nₚ is the refractive index of the nanoparticle;

nₒ is the refractive index of free space; and

p is the pitch or separation distance between the centers of adjacent or nearest neighbor nanoparticles.

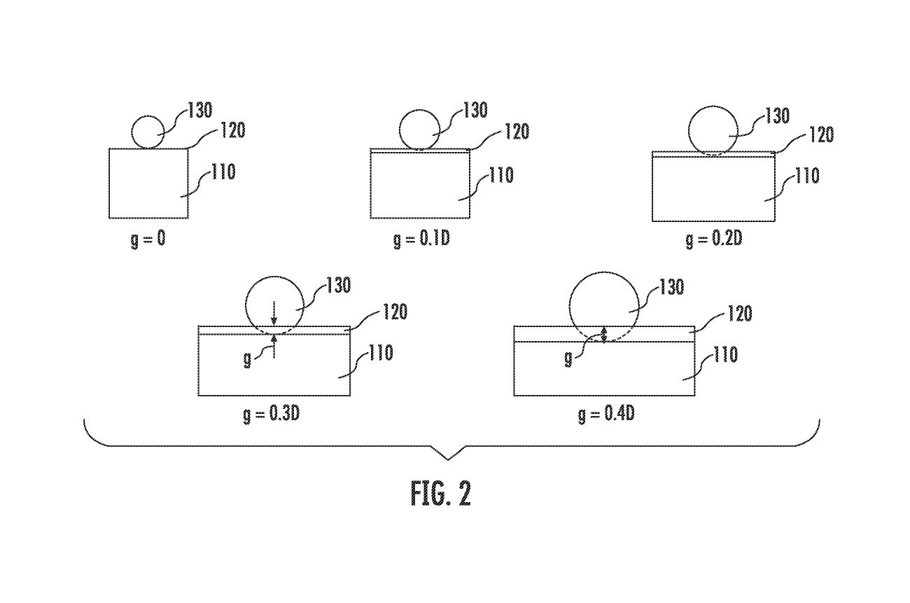

FIG. 2 shows a series of simulated cross sections of minimal reflectivity structures for a series of relative integral binder levels, such as the nanoparticle immersion depth or integral binder region thickness (g) as a function of spherical particle diameter (D). The simulations treated all three refractive indices (nₛ, n_{g}, and nₚ) as equal to 1.5.

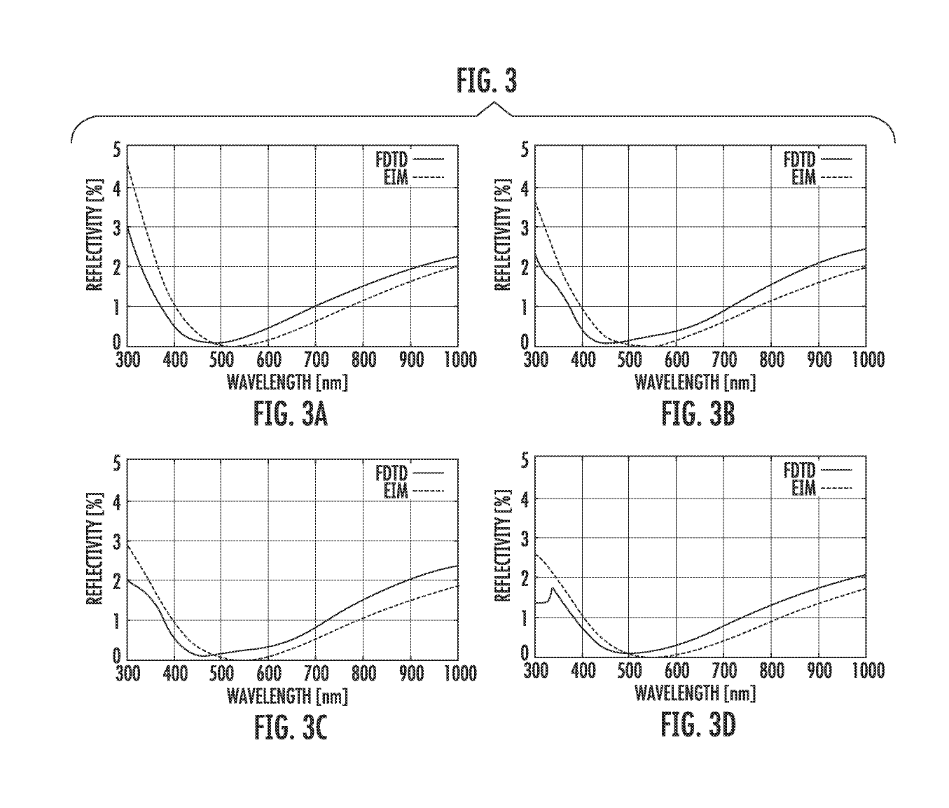

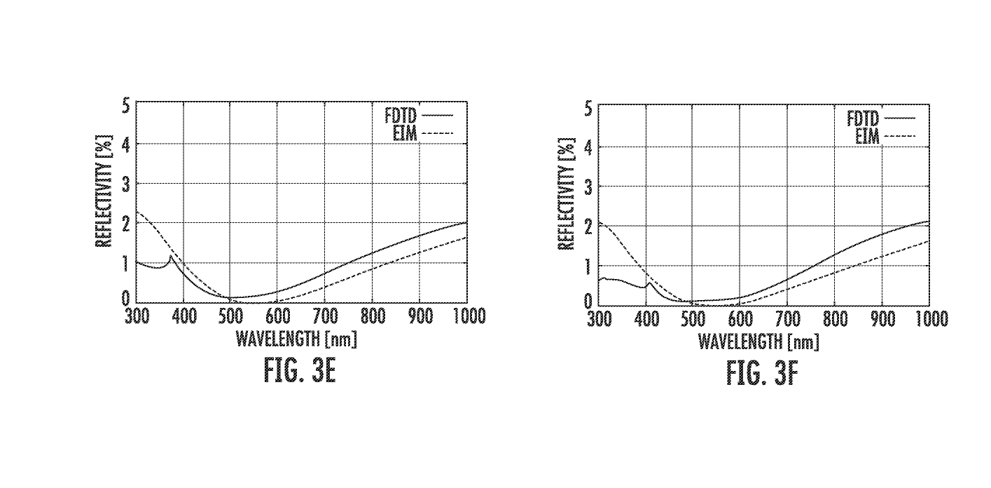

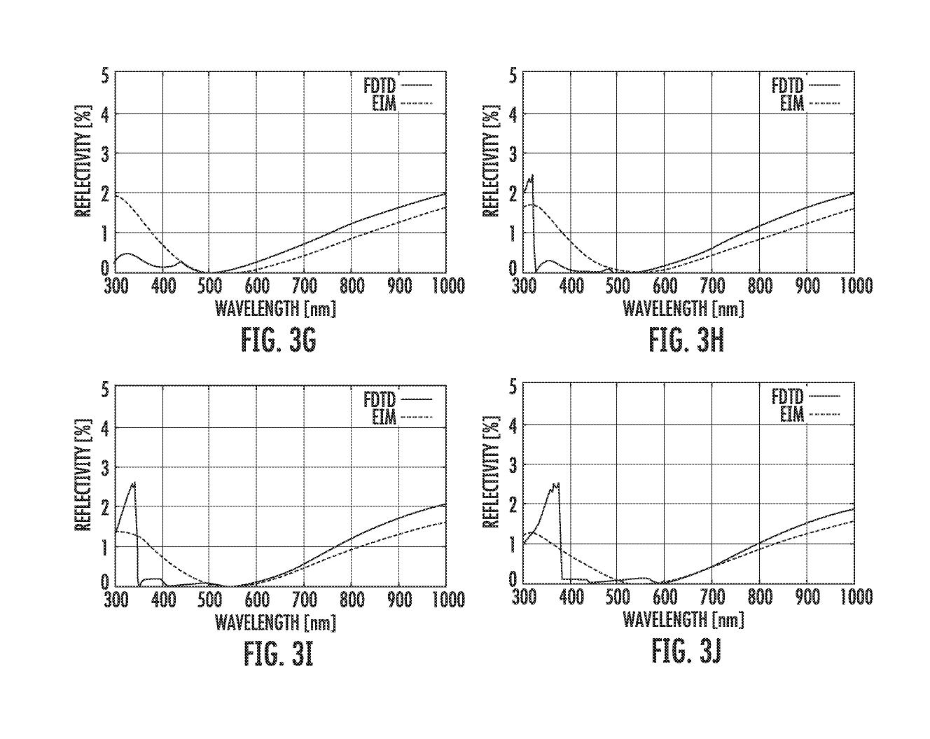

FIG. 3A to 3J show a series of graphs of the reflectivity in percent (%) as a function of wavelength for a series of integral binder-level thicknesses at preferred design points, in terms of the structural parameters, for example: the integral binder level or extent of particle immersion dimension or submersion amount (g), the average center-to-center particle spacing or pitch (p), and the spherical particle diameter (D). In these graphs, the immersion dimension (g) and the pitch (p) are given in units of the spherical particle diameter (D). The graphs show two curves: finite-difference time-domain (FDTD)(solid line), which is a rigorous simulation of the electromagnetic field interacting with the dielectric structure; and effective index model (EIM)(dashed line), which breaks up the three-dimensional dielectric structure into planar slices, determines an effective index in each slice, then determines the reflectivity of the stack of dielectric layers. The EIM is an excellent approximation when the lateral scale of the structure is much smaller than a wavelength. The FDTD is applicable at all sufficiently sampled scales. Note how the FDTD model shows resonant features below 400 nm. This indicates that the sub-wavelength structure assumption for the EIM is a good approximation for wavelengths longer than 400 nm, which is reinforced by the excellent agreement between the FDTD and EIM results for wavelengths longer than 400 nm. Table 1 tabulates the integral binder region thickness (g), the pitch to particle diameter (p/D) ratio, and particle size diameter (D) of the reflectivity versus wavelength for the modeled (FDTD and EIM) results plotted in FIGS. 3A to 3G.

TABLE 1

| FIG. 3 | g/D | p/D | D (nm) |
|---|---|---|---|
| 3A | 0 | 1.325 | 110 |
| 3B | 0.1 | 1.375 | 130 |
| 3C | 0.2 | 1.425 | 160 |
| 3D | 0.25 | 1.425 | 180 |
| 3E | 0.3 | 1.425 | 200 |
| 3F | 0.35 | 1.425 | 220 |
| 3G | 0.4 | 1.4 | 240 |
| 3H | 0.45 | 1.375 | 270 |
| 3I | 0.5 | 1.325 | 300 |
| 3J | 0.55 | 1.25 | 350 |

In embodiments, the disclosed article having surface associated particles can be prepared by, for example, depositing or adding an optional protective coating or layer on a particulated surface, which protective coating layer partially coats the particles, e.g., partially fills or covers at least a portion of the particles.

In embodiments, the disclosed antireflective article can have the surface associated particles being completely submerged in the integral binder region (i.e., where g is approximately equal to D). The refractive index of the integral binder and particles can be selected to be, for example, comparable, such as from or within from 1.1 to 1.8, from 1.2 to 1.8, from 1.25 to 1.8, from, from 1.3 to 1.8, from 1.3 to 1.75, from 1.25 to 1.7, from 1.3 to 1.65, from 1.3 to 1.6, from 1.3 to 1.55, from 1.35 to 1.50, including intermediate values and ranges. The refractive index of the integral binder region or layer (n_{g}), the particles (nₚ), and the substrate (nₛ), can be selected to be, for example, 1.3≦n_{g}≦1.8, 1.3≦nₚ≦1.8, and 1.3≦nₛ≦1.8.

In embodiments, the disclosed article having surface associated particles can also be prepared by, for example, softening the substrate by, for example, heating (or irradiating), to sink the surface associated particles down into the surface of the softened substrate, i.e. integral binder layer. A refractive index of 1.5 was used for the integral binder layer in the modeling calculations.

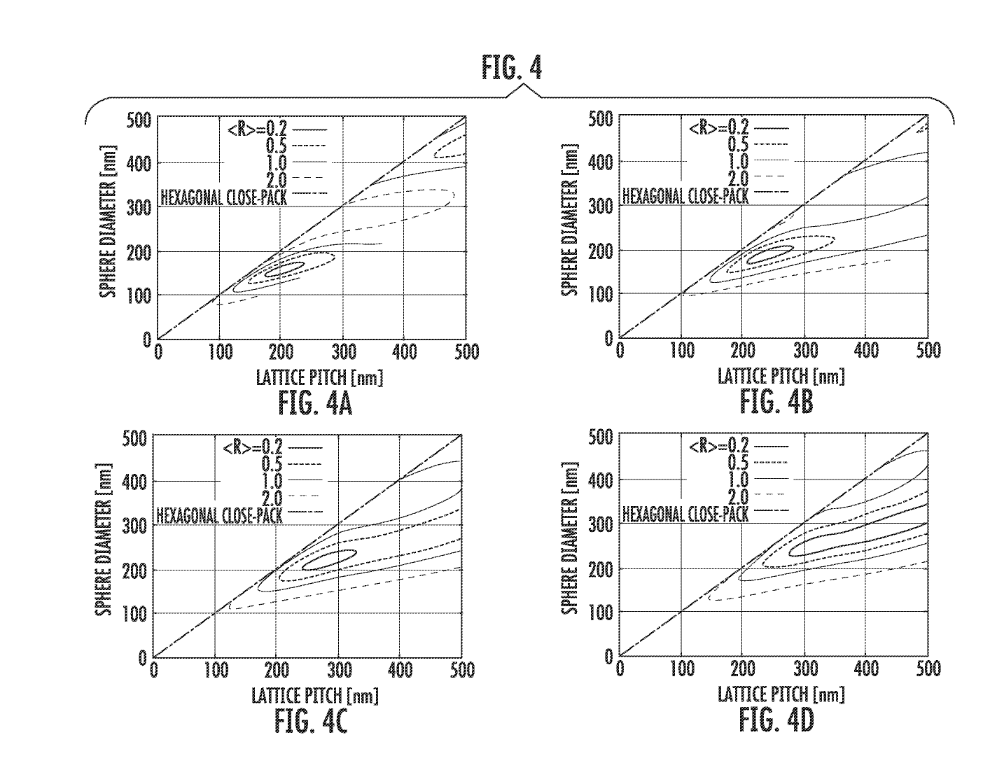

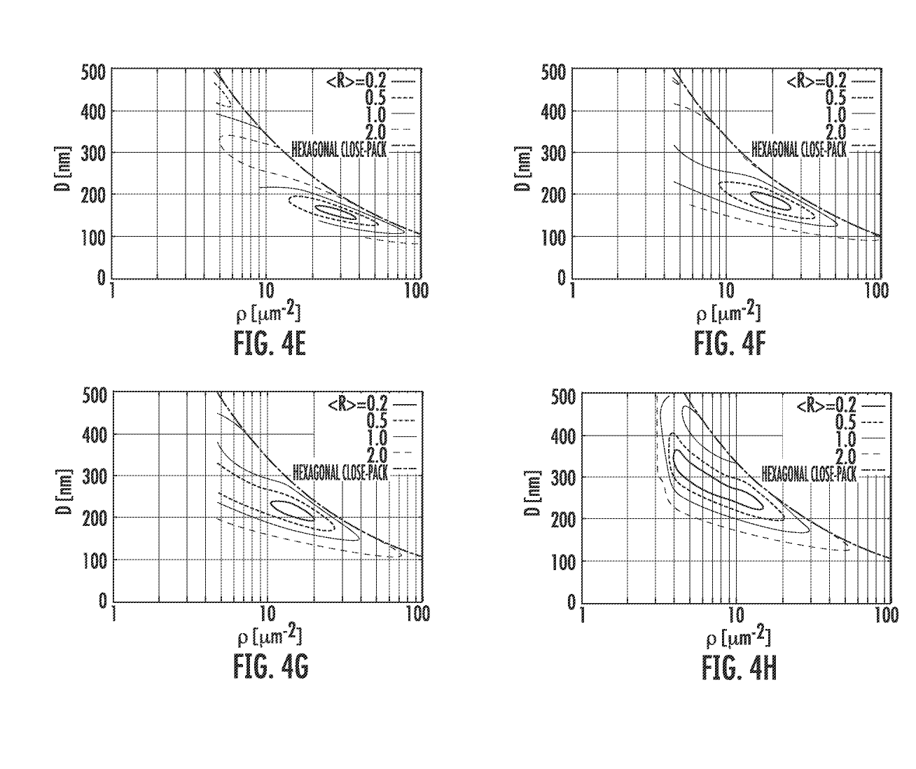

FIGS. 4A to 4H is a series of graphs that show contours of the averaged reflectivity (“<R>”), the spectral reflectivity averaged from 450 to 650 nm, and normalized by 200 nm to give the average reflectivity in percent. Within each graph, the integral binder level or the amount the particulate spheres is sunken into the substrate surface (integral binder) or extrinsic binder is a fixed percentage of the spherical particle diameter (D). The smallest contour curve shows an average reflectivity of 0.2% across 450-to-650 nm. Points within the solid line contour have average reflectivity <R> less than 0.2%. The other larger curves are average reflectivity of 0.5%, 1.0%, and 2.0%, respectively. The straight line represents a hexagonal close-pack configuration. The amount of integral binder in fractional percentage of the nanoparticle diameter (D) for: FIGS. 4A and 4E is 16.7%; FIGS. 4B and 4F is 25%; FIGS. 4C and 4G is 33.3%; FIGS. 4D and 4H is 40%. The average density (p) (FIGS. 4E to 4H) is related to the average particle spacing (p) or pitch (FIGS. 4A to 4D) via the relation of equation (1):

ρ=2/(√3p²) (1).

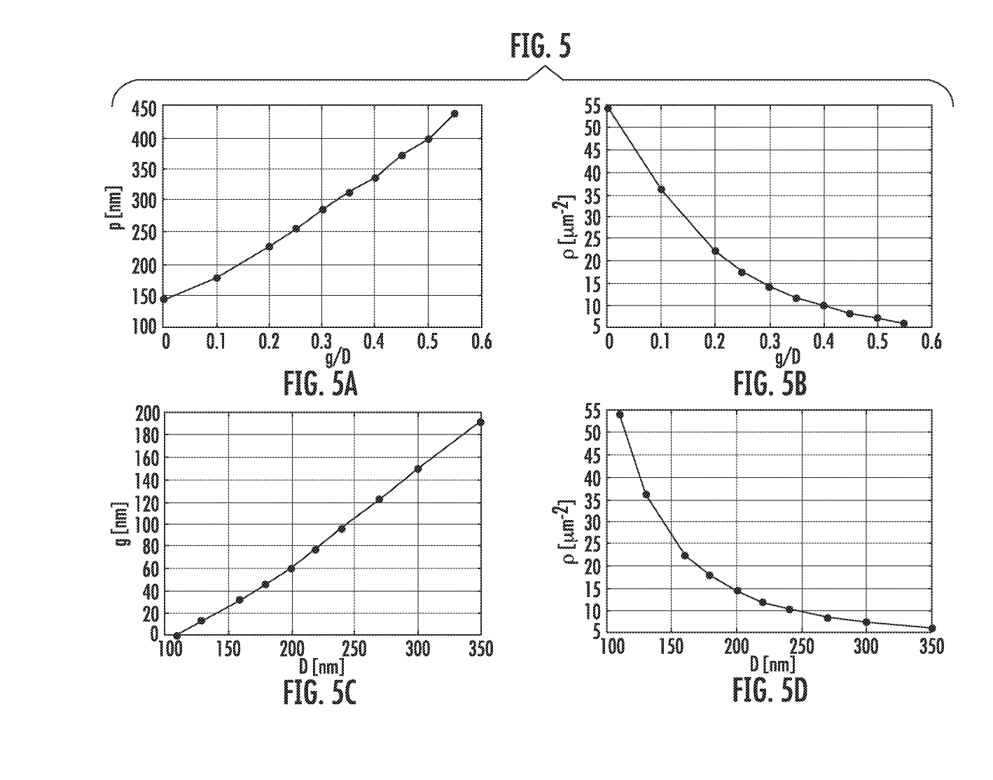

FIGS. 5A to 5D show plots of the preferred design parameters plotted against one another. FIG. 5A shows a preferred average center-to-center spacing or pitch (p) range between particles as a function (g/D) of the integral binder level thickness (g) range relative to a preferred diameter (D) range of the particles. FIG. 5B shows a preferred average density (p) range of particles as a function (g/D) of the integral binder level thickness (g) range relative to a preferred diameter (D) range of the particles. FIG. 5C shows a preferred integral binder level thickness (g) range as a function of a preferred diameter (D) range of the particles. FIG. 5D shows a preferred particle density (p) range as a function of the preferred diameter (D) range of the particles. Each point is a minimum taken from contour plots such as shown in FIG. 4.

In embodiments, a diameter (D) range of the particles can be, for example, from 50 nm to about 350 nm, from 100 to 300 nm, including intermediate values and ranges. In embodiments, a pitch (p) range between particles can be, for example, from 120 to 450 nm, including intermediate values and ranges. In embodiments, an average density (p) range of particles can be, for example, from 5 to 55 (microns⁻²), including intermediate values and ranges. In embodiments, a integral binder level thickness (g) range can be, for example, from 0 (that is where the binder is integral to the substrate and there is no separate binder layer per se) to 5,000 nm, from 5 nm to 5,000 nm, from 5 nm to 2,500 nm, from 5 nm to 1,000 nm, from 5 nm to 500 nm, from 5 nm to 250 nm, from 5 nm to 200 nm, from 5 nm to about 150 nm, and from 10 nm to 100 nm (that is where the binder is a separate layer per se and g is not equal to zero), including intermediate values and ranges.

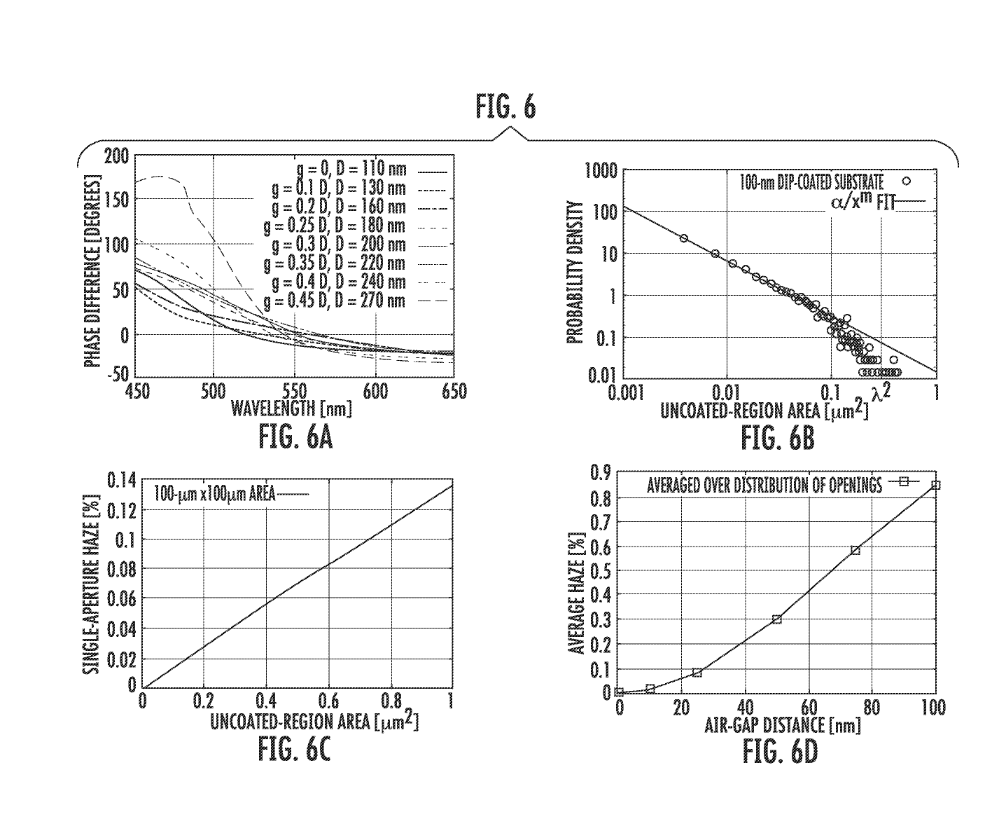

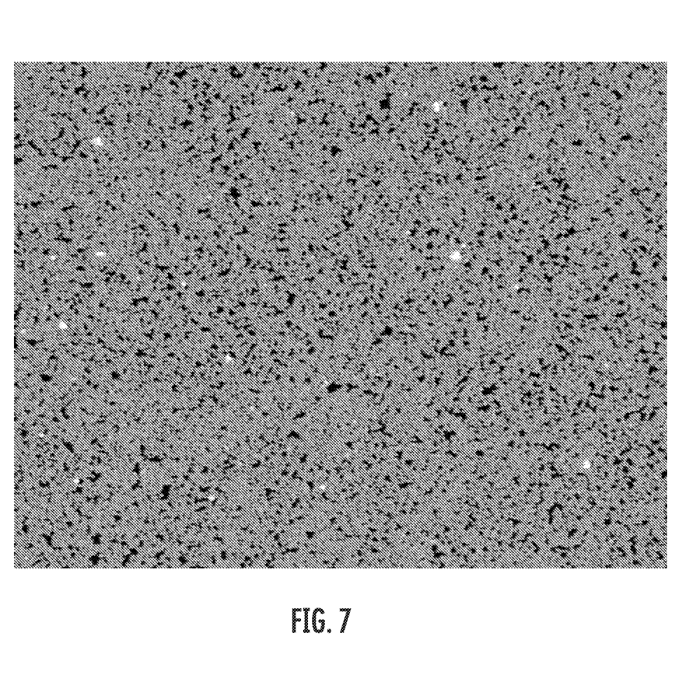

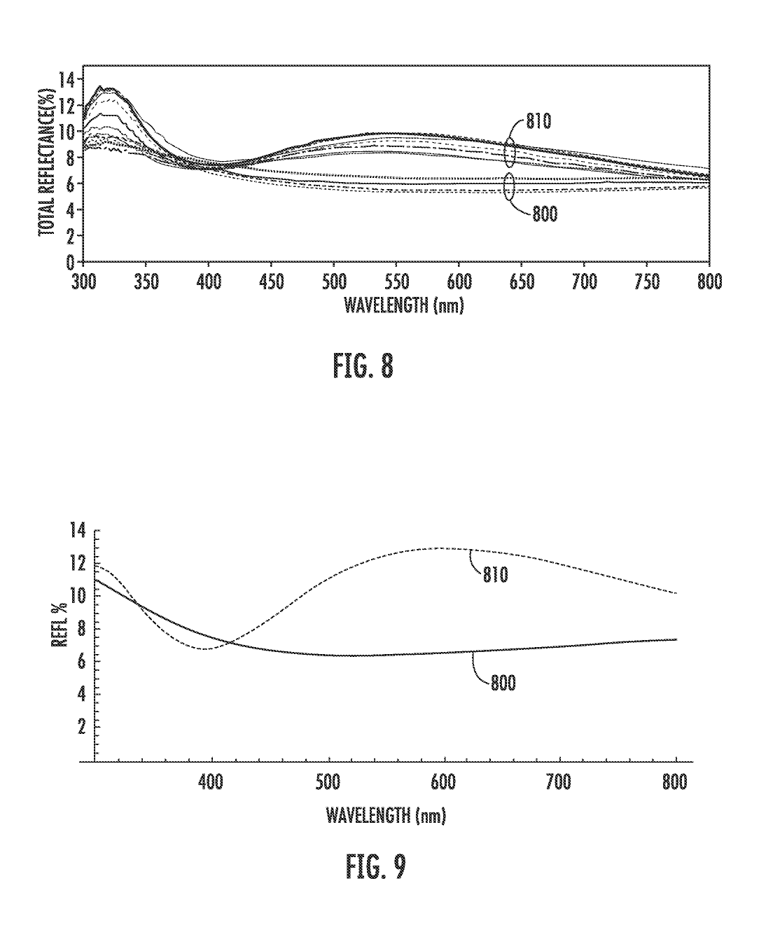

FIGS. 6A to 6D show the impact of variations in the particle density on optical haze.

FIG. 6A shows phase difference between light reflected from an uncoated void region and light reflected from a monolayer of silica spheres of diameter (D) and integral binder-layer thickness or extent of particle submersion (g), which is at the low-reflectivity design point. As the integral binder-layer thickness increases and the preferred diameter increases, the beginning of structural resonance affecting the differential phase shift at shorter wavelengths can be seen.

FIG. 6B shows probability density of an uncoated region as a function of the uncoated area as measured for 120 nm diameter particles that were dip coated onto a substrate.

FIG. 6C shows haze (%) from a single uncoated region in a 100-microns-by-100-microns coated region as a function of the area of the single uncoated region for a fixed differential phase.

FIG. 6D shows average haze (%) as a function of the differential phase shift between coated and uncoated regions of the randomly particle coated surface. In this instance the haze is averaged over the distribution of uncoated areas. The air gap distance in nanometers is the additional distance the optical field propagates when reflected from an uncoated region compared to that reflected from the region coated with the average particle density.

FIG. 7 shows an atomic-force microscope height image of an exemplary glass surface that was dip-coated to provide a particulated substrate surface having, for example, 120 nm silica spheres and without an integral binder layer or free of a binder layer. The bright patches or regions of the image are particles resting on top of the primary monolayer of the coating (i.e., double layer). The dark areas are regions of the coating that are free of particles, and the areas of intermediate gray are clusters of monolayers of nanoparticles.

In embodiments, the method of making can include or further comprise, for example, strengthening the substrate by ion-exchange before, after, or both before and after, applying the monolayer of nanoparticulates to the at least one transiently softened surface of surface of the substrate (ionic exchange method; see for example, commonly owned and assigned copending U.S. patent application Ser. No. 12/856,840, published as US patent application publication 20110045961).

FIG. 8 contains measured data for specular reflectance % of a batch of samples over the wavelengths 300 to 800 nm using 100 nm (800) and 250 nm (810) diameter silica spheres coated onto an ionically exchanged glass substrate. [A1]

FIG. 9 contains reflectance % data calculated using the effective index model (EIM) and is compared to the ion exchanged sample data mentioned in FIG. 8. The EIM modelled results shown in FIG. 9 agree well with the shape of the reflected spectrum (i.e., total reflectance %) for both particle sizes (i.e., 100 nm and 250 nm).

Excellent agreement was observed between the actual and modelled results even in the absence of packing density. The packing density, or ratio of pitch to diameter (p/D), was estimated from SEMs to be 1.07. The particle diameters (D) selected were 100 nm (800) and 250 nm (810).

In FIG. 9, reflections were calculated at normal incidence (theta=0), p/D is equal to 1.07, nₛ is equal to 1.51, nₚ is equal to 1.457, n_{g} is equal to 1.52; and a 6% offset was added to the modelled data to account for back face reflection and scattering. The reflection from one surface was modelled. However, measurements are accomplished on real glass substrate samples having at least two sides or at least two surfaces. Accordingly, it is necessary to add an additional reflection from the back face to the data. The added offset does not affect the spectral shape of the curve but permits convenient comparison of the graphed data.

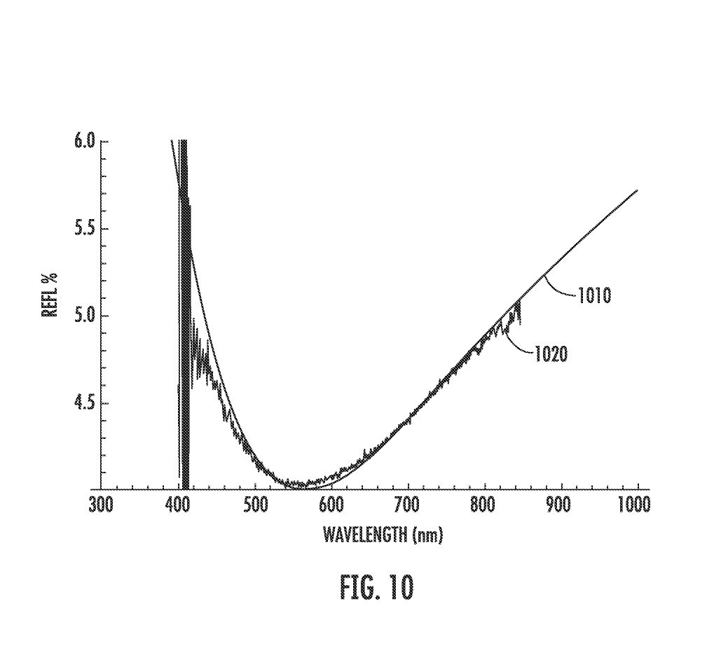

FIG. 10 shows a comparison between the EIM model results (single line curve) (1010) and the measured reflected spectrum (complex curve) (1020) of the sample shown in FIG. 7, and was used for calculations to estimate Haze. In FIG. 10, D is equal to 120 nm, the pitch to diameter ratio (p/D) is equal to 1.3, nₛ is equal to 1.51, nₚ is equal to 1.46, and the modelled curve had a standard 4% offset to account for back face reflection, which is present in the measured data. It is important to note that not only the spectral shape but also the absolute value of the reflection is predicted by the model. Both of the experimental comparisons were in agreement with the EIM model The excellent agreement between the modelled and experimental spectral shapes and the overall reflectance levels indicates the disclosed sample fabrication process is highly predictable. The experimental observations demonstrate that the model predicts both shape and absolute value of the reflection.

In embodiments, the disclosure provides a low-reflectivity surface including a random monolayer coating of nearly mono-disperse sub-wavelength spherical oxide particles, such as silica particles having a binder region of limited thickness between the particles and substrate. Alternatively, the particles can be partially submerged or immersed into the surface of the substrate (i.e., an integral binder).

In embodiments, a single layer of randomly distributed particles covers the surface with an average density (ρ). The average particle density (ρ) is defined as the average number of particles per unit area on the surface of the substrate, where the average is taken over the random distribution of particles on the surface. The average particle spacing or pitch (p) is the average center-to-center space between adjacent particles and is related to the average particle density (ρ) by (a rearranged form of above equation (1)):

p=√(2/(√(3)ρ).

The spherical particles have a diameter (D) and the integral binder-layer has thickness (g). These parameters include at least, for example: particle diameter (D); the integral binder-layer has thickness (g); and pitch (p), and these three parameters are sufficient to determine a desired structure having the desired AR properties.

In embodiments, the disclosure provides a broadband anti-reflective coating having a monolayer or a near monolayer of nanoparticles. A “near monolayer of nanoparticles” refers to a monolayer that is, for example, incomplete by from 0.1 to 5% uncovered surface area, and complete by from 95 to 99.9% nanoparticles surface area coverage. The nanoparticles comprising the monolayer can have a diameter (D), for example, from 50 to 500 nm, a preferred diameter from 100 to 300 nm, and more preferred diameter from 150 to 280 nm. The monolayer of nanoparticles can consist of nano-spheres, hemispheres, and like geometries, or combinations thereof.

In embodiments, the nanoparticle layer can have voids or gaps, that is one or more unparticulated areas of, for example, from about 0.1 to about 1.5 square microns, including intermediate values and ranges, such as less than 1 square micron, preferably less than 0.5 square micron, and more preferably less than 0.25 square micron.

In embodiments, the integral binder region layer can be comprised of the substrate itself, i.e., an integral binder region or binder layer, for example, having at least a portion of the surface of the substrate temporarily softened or otherwise modified to allow partial immersion or submersion of the deposited or applied particles onto or into the softened substrate surface and then the softened substrate can be re-solidified by, for example, cooling at ambient temperatures.

At the interface between the monolayer of nanoparticles and substrate there can be disposed at least one integral binder region having a refractive index that is identical to or comparable to the refractive index of the substrate, the nanoparticles, or both the substrate and the nanoparticles. The refractive index of the integral binder region can be modified to be different from the refractive index of the substrate by, for example, including an additive or dopant in the integral binder region while, for example, the integral binder region is transiently generated, such as by softening. This integral binder region lowers the reflection or broadens the band of low reflection that is created by the AR coating and helps to attach or adhere the particles to the substrate. The transparent substrate can be, for example, glass or other transparent material and like materials, such as a polymer, a plastic, a composite, a transparent sol-gel product, a transparent glass-ceramic material, or a combination thereof.

The slope of the preferred particle density (ρ) as a function of the particle diameter (D) gives a measure of the sensitivity of the surface structure to fluctuations in these two parameters (particle density and particle diameter). For small spheres having a diameter of from 50 to about 200 nm, which small spheres correspond to a thin integral binder region, the steep slope as shown in FIG. 5D indicates that the surface structure is relatively insensitive to the average particle density (ρ). For larger spheres having a diameter of from 200 to about 500 nm, which larger spheres correspond to thicker integral binder layer regions, the surface structure becomes insensitive to the spherical particle diameter, implying the spherical particle structure could employ non-mono-disperse distributions of spherical particles. Additionally, using the average reflectivity contour plots, such as FIGS. 4A to 4H, one can determine the sensitivity to changes in the diameter (D) and average particle spacing (p).

Anti-reflective behaviour for display devices is particularly important in the visible spectrum. However, through scale invariance, the presently disclosed structures can be applied to any wavelength range of an application. For higher-index materials, the scale or size of the spheres can be reduced to provide the same optical path and relative refractive index gradient as contained in the structures disclosed here.

Calculations were accomplished for all materials having the same (equal) or substantially the same refractive index (n) equal to 1.5, or a comparable refractive index. It was observed that small changes in the refractive indices of the sphere, the substrate, or the integral binder region did not lead to significant deviations from the disclosed design principals and structures. Accordingly, similar performance is expected for refractive indices of from 1.4 to 1.6. The approach to developing the structures for higher (or lower) refractive index materials remains valid, but in that instance deviations in reflectivity and haze from the disclosed structures here can be expected. Haze is a measure of the diffuse scattering (i.e., angular scattering at angles greater than 2.5 degrees away from the specular direction) divided by the total scattering. For periodic sub-wavelength structures, there is no scattering, since all diffractive orders are evanescent. Scattering from collections of sub-wavelength particles only develops when the particles deviate from a periodic lattice. Images of particles deposited on the surface with the presently disclosed low-cost manufacturing processes show the particles collect predominantly into monolayer clusters with uncoated voids between the clusters. Light reflected from the voids accumulate a phase shift different from that of light reflected from the array of particles surrounding the uncoated region. This differential phase shift is wavelength and structure dependent. The differential phase shift is shown in the figures, such as FIG. 6A. For preferred design parameters with integral binder levels (g) below about 45% or 0.45×D of the preferred particle diameter (D), the differential phase shift is similar among all the structures. The haze generated by an uncoated region surrounded by clusters of particles increases with increasing void area and increasing differential phase shift. Because the differential phase shifts of the low-reflectivity structures are very similar, the haze will not be strongly affected by the choice of structure, but will be most strongly influenced by the area probability density of uncoated regions.

The haze of a particle-coated surface can be estimated by summing the product of the haze produced by a given uncoated area times the probability of having an uncoated area of that size. This sum thus produces the expected average haze of the collection of open areas that follow the uncoated area probability density.

Because the disclosed low-reflectivity structures have nearly identical differential phase shifts between the coated and uncoated regions of the surface, the average haze can be determined primarily by the probability density function of the uncoated regions. If the particle-coating process for particle size diameters between 100 and 300 nm produces uncoated regions that have similar area probability densities, then the haze predicted from these structures are similar. If, however, the relative areas of the voids scale with particle size, then the area of the voids will increase in proportion to the relative increase in particle diameter squared (e.g., going from 100 to 300 nm diameter, the haze would increase by nine times). The disclosed low reflectivity or AR coating structures having smaller diameter particles should show lower haze values than larger diameter particles structures. Under the assumption that the coating of particles is scale invariant over the 100 to 300 nm range in diameters, the assumption may be flawed, since at different scales the relative strength of different self-organizing forces acting on the particles can change in relative importance. For example, the surface area of the spheres increases by roughly ten times going from 100 nm diameter to 300 nm diameter spheres, while the volume increases by a factor of 27.

Additionally, the haze will be more dramatically impacted by uncoated regions whose areas are comparable or larger than a square wavelength. Random coating processes that have uncoated areas that are small compared to a square wavelength or have a relatively small probability of having uncoated areas larger than or on the order of a square wavelength will produce less haze than surfaces that do contain such large uncoated areas. This is mainly due to the optical resolving power of the optical far field. The far field does not contain information about transverse scales that are small compared to a wavelength, so that small voids do not affect the far field and cannot be seen by observers using the far field.

In embodiments, the integral binder region can be transiently generated, by for example, softening the surface of the transparent substrate by any of a variety of methods known such as heating, radiation, friction, mechanical impact, stamping, and like methods, or combinations thereof.

The nanoparticle monolayer can be deposited from an aqueous or solvent-based suspension using, for example, dip coating, spin coating, spray coating, and like methods, or combinations thereof. The nanoparticle monolayer can optionally be fused to the surface of the substrate by, for example, thermalizing the surface of the substrate, thermalizing the particles, or both, before or after the nanoparticles have been deposited on the substrate. The nano-particle monolayer can optionally be fused to the surface of the integral binder region by, for example, the addition of a very thin layer, for example, on the surface of the particles or at the interface between the integral binder region and the nanoparticles. The very thin, such as having a thickness of from 1 to 10 nm, layer of, for example, siloxane, sol-gel SiO₂, or fumed silica soot material applied by, for example, dip or spray coating, of yet another material can act an secondary binder material.

In embodiments, the nanoparticle monolayer can be formed first on an alkali silicate glass substrate using, for example, dip coating, spin coating, spray coating, and like methods, or combinations thereof. The nanoparticle monolayer can optionally be fused to the surface of the glass, such as alkali silicate glass, through thermal sintering. The alkali silicate glass can then be optionally chemically strengthened by, for example, ion-exchange of smaller ions in the glass with larger native ions, e.g., native sodium ions exchanged with potassium ions.

In embodiments, the glass substrate or glass article can comprise, consist essentially of, or consist of one of a soda lime silicate glass, an alkaline earth aluminosilicate glass, an alkali aluminosilicate glass, an alkali borosilicate glass, and combinations thereof. In embodiments, the glass article can be, for example, an alkali aluminosilicate glass having the composition: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{{\sum }_{ } alkali metal modifiers ( mol \% )} > 1 ,$$

where the alkali metal modifiers are alkali metal oxides. In embodiments, the alkali aluminosilicate glass substrate can be, for example: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In embodiments, the alkali aluminosilicate glass substrate can be, for example: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %. In embodiments, the alkali aluminosilicate glass substrate can be, for example: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %. In embodiments, the alkali aluminosilicate glass can be, for example: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂O≦0.5. In embodiments, the alkali aluminosilicate glass can be, for example, substantially free of lithium. In embodiments, the alkali aluminosilicate glass can be, for example, substantially free of at least one of arsenic, antimony, barium, or combinations thereof. In embodiments, the glass can optionally be batched with 0 to 2 mol % of at least one fining agent, such as Na₂SO₄, NaCl, NaF, NaBr, K₂SO₄, KCl, KF, KBr, SnO₂, at like substances, or combinations thereof.

In embodiments, the selected glass can be, for example, down drawable, i.e., formable by methods such as slot draw or fusion draw processes that are known in the art. In these instances, the glass can have a liquidus viscosity of at least 130 kpoise. Examples of alkali aluminosilicate glasses are described in commonly owned and assigned U.S. patent application Ser. No. 11/888,213, to Ellison, et al., entitled “Down-Drawable, Chemically Strengthened Glass for Cover Plate,” filed Jul. 31, 2007, which claims priority from U.S. Provisional Application 60/930,808, filed May 22, 2007; U.S. patent application Ser. No. 12/277,573, to Dejneka, et al., entitled “Glasses Having Improved Toughness and Scratch Resistance,” filed Nov. 25, 2008, which claims priority from U.S. Provisional Application 61/004,677, filed Nov. 29, 2007; U.S. patent application Ser. No. 12/392,577, to Dejneka, et al., entitled “Fining Agents for Silicate Glasses,” filed Feb. 25, 2009, which claims priority from U.S. Provisional Application No. 61/067,130, filed Feb. 26, 2008; U.S. patent application Ser. No. 12/393,241, to Dejneka, et al., entitled “Ion-Exchanged, Fast Cooled Glasses,” filed Feb. 26, 2009, which claims priority to U.S. Provisional Application No. 61/067,732, filed Feb. 29, 2008; U.S. patent application Ser. No. 12/537,393, to Barefoot, et al., entitled “Strengthened Glass Articles and Methods of Making,” filed Aug. 7, 2009, which claims priority to U.S. Provisional Application No. 61/087,324, entitled “Chemically Tempered Cover Glass,” filed Aug. 8, 2008; U.S. Provisional Patent Application No. 61/235,767, to Barefoot, et al., entitled “Crack and Scratch Resistant Glass and Enclosures Made Therefrom,” filed Aug. 21, 2009; and U.S. Provisional Patent Application No. 61/235,762, to Dejneka, et al., entitled “Zircon Compatible Glasses for Down Draw,” filed Aug. 21, 2009.

The glass surfaces and sheets described in the following example(s) can use any suitable particle-coatable glass substrate, or like substrates such as ion exchanged substrates, and can include, for example, a glass composition 1 through 11, or a combination thereof, listed in Table 2.

TABLE 2
Representative glass substrate compositions.

| Glass> | | | | | | | | | | | |
|---|---|---|---|---|---|---|---|---|---|---|---|
| Oxides | | | | | | | | | | | |
| (mol %) | 1 | 2 | 3 | 4 | 5 | 6 | 7 | 8 | 9 | 10 | 11 |
| SiO₂ | 66.16 | 69.49 | 63.06 | 64.89 | 63.28 | 67.64 | 66.58 | 64.49 | 66.53 | 67.19 | 70.62 |
| Al₂O₃ | 10.29 | 8.45 | 8.45 | 5.79 | 7.93 | 10.63 | 11.03 | 8.72 | 8.68 | 3.29 | 0.86 |
| TiO₂ | 0 | | | — | — | 0.64 | 0.66 | 0.056 | 0.004 | — | 0.089 |
| Na₂O | 14 | 14.01 | 15.39 | 11.48 | 15.51 | 12.29 | 13.28 | 15.63 | 10.76 | 13.84 | 13.22 |
| K₂O | 2.45 | 1.16 | 3.44 | 4.09 | 3.46 | 2.66 | 2.5 | 3.32 | 0.007 | 1.21 | 0.013 |
| B₂O₃ | 0.6 | | 1.93 | — | 1.9 | — | — | 0.82 | — | 2.57 | — |
| SnO₂ | 0.21 | 0.185 | — | — | 0.127 | — | — | 0.028 | — | — | — |
| BaO | 0 | — | — | — | — | — | — | 0.021 | 0.01 | 0.009 | — |
| As₂O₃ | 0 | — | — | — | — | 0.24 | 0.27 | | — | 0.02 | — |
| Sb₂O₃ | — | — | 0.07 | — | 0.015 | — | 0.038 | 0.127 | 0.08 | 0.04 | 0.013 |
| CaO | 0.58 | 0.507 | 2.41 | 0.29 | 2.48 | 0.094 | 0.07 | 2.31 | 0.05 | 7.05 | 7.74 |
| MgO | 5.7 | 6.2 | 3.2 | 11.01 | 3.2 | 5.8 | 5.56 | 2.63 | 0.014 | 4.73 | 7.43 |
| ZrO₂ | 0.0105 | 0.01 | 2.05 | 2.4 | 2.09 | — | — | 1.82 | 2.54 | 0.03 | 0.014 |
| Li₂O | 0 | — | — | — | — | — | — | — | 11.32 | — | — |
| Fe₂O₃ | 0.008 | 10.008 | 0.0083 | 0.008 | 0.0083 | 0.0099 | 0.0082 | 0.0062 | 0.0035 | 0.0042 | 0.0048 |
| SrO | — | — | — | 0.029 | — | — | — | — | — | — | — |

U.S. Pat. No. 8,202,582, to Shinotsuka, mentions a two dimensional close packed microstructure used as single particle film etching mask in making an antireflection surface. The etching mask is produced by a dripping step, a volatizing step, and a transferring step in which the single particle film is transferred to a substrate. The single particle film etching mask has a misalignment D(%) of an array of the particles defined by:

D(%)=|B−A|times100/A

being less than or equal to 10%, where A is the average diameter of the particles, and B is the average pitch between the particles in the film

### EXAMPLE(S)

The following examples serve to more fully describe the manner of using the above-described disclosure, and to further set forth best modes contemplated for carrying out various aspects of the disclosure. These examples do not limit the scope of this disclosure, but rather are presented for illustrative purposes. The working example(s) further describe(s) how to prepare the disclosed

### Preparation of Particulated Surfaces

### Example 1

### Prophetic

Preparation of Particulated Surfaces Having Substantially Uniform Spacing or Separation Between Adjacent Particles, i.e., Having a Non-Close Pack Hexagonal Geometry, and an Integral Binder Layer.

Several methods have been demonstrated for fabricating non-close-packed nanoparticle monolayers with controlled spacing between particles on various substrates, including demonstrations of anti-reflective effects. These methods include convective assembly on a lithographic pattern (see for example, Hoogenboom, et. al., “Template-Induced Growth of Close-Packed and Non-Close-Packed Colloidal Crystals during Solvent Evaporation”, Nano Letters, 4, 2, p. 205, 2004.); dip-coating of hydrogel spheres, which can be made to shrink during drying or heating after deposition (see Zhang, et. al., “Two-Dimensional Non-Close-Packing Arrays Derived from Self-Assembly of Biomineralized Hydrogel Spheres and Their Patterning Applications”, Chem. Mater. 17, p. 5268, 2005, and FIG. 3 and associated text); spin-coating and shear alignment of SiO₂ nanospheres, optionally with further material added to this template (see Venkatesh, et. al., “Generalized Fabrication of Two-Dimensional Non-Close-Packed Colloidal Crystals,” Langmuir, 23, p. 8231, 2007, and FIG. 5 and associated text); and electrostatically controlled self-assembly at air-water or alkane-water interfaces with transfer to a substrate, optionally using a very thin (about 17 nm) adhesive layer (see Ray, et. al., “Submicrometer Surface Patterning Using Interfacial Colloidal Particle Self-Assembly”, Langmuir, 25, p. 7265, 2009, and FIG. 8 and associated text; Bhawalkar, et. al., “Development of a Colloidal Lithography Method for Patterning Nonplanar Surfaces”, Langmuir, 26, p. 16662, 2010). However, these previous works did not specify the desired relationships between the particle size, the particle spacing, the particle sinking into an integral binder region of a substrate, and that are specified in the present disclosure for achieving excellent low-reflection performance for visible light, together with enhanced durability due to the optional particle sinking or sintering.

The disclosure has been described with reference to various specific embodiments and techniques. However, it should be understood that many variations and modifications are possible while remaining within the scope of the disclosure.

What is claimed is:

1. An anti-reflective article, comprising:
a substrate;
an integral binder region on at least a portion of the surface of the substrate; and
a nanoparticulate monolayer partially embedded in the integral binder region, wherein the ratio of the thickness of the integral binder region (g) to the thickness or diameter (D) of the nanoparticulate monolayer (g:D) is from 1:50 to 3:5.

2. The article of claim 1 wherein the substrate, the integral binder region, and the nanoparticulates of the nanoparticulate monolayer are each independently selected from at least one of a glass, a polymer, a ceramic, a composite, or a combination thereof.

3. The article of claim 1 wherein the partially embedded nanoparticulate monolayer comprises nanoparticles having an average diameter (D) of from 50 nm to about 300 nm.

4. The article of claim 1 wherein the integral binder region compromises the surface of the substrate having nanoparticles partially embedded into the surface of the substrate at an immersion depth (g) of from 1 nm to about 150 nm, and the nanoparticulate monolayer comprises nanoparticles having an average diameter (D) of from 50 nm to about 300 nm.

5. The article of claim 1 wherein the nanoparticles of the nanoparticulate monolayer comprise spheres of silica having an average diameter (D) less than at least one wavelength of visible light.

6. The article of claim 1 wherein the nanoparticulate monolayer has a plurality of unparticulated voids or areas of at least from 0.1 to 1 square microns.

7. The article of claim 1 wherein the nanoparticulate monolayer is comprised of sub-wavelength spherical silica particles.

8. A method of making the article of claim 1, comprising:
applying a monolayer of nanoparticulates to the integral binder region comprising at least one transiently softened surface of the substrate.

9. The method of claim 8 wherein applying the monolayer of nanoparticulates to the at least one transiently softened surface of surface of the substrate is accomplished by dip coating the substrate having the transiently softened surface into a mixture of the nanoparticulates.

10. The method of claim 8 wherein the at least one transiently softened surface of the substrate is accomplished before applying the monolayer of nanoparticulates to the surface of the substrate, and the applied nanoparticulates partially sink into the surface of the transiently softened substrate.

11. The method of claim 8 wherein the at least one transiently softened surface of the substrate is accomplished after applying the monolayer of nanoparticulates to the surface of the substrate, and the applied nanoparticulates partially sink into the surface of the transiently softened substrate.

12. The method of claim 8 wherein the monolayer of nanoparticulates is comprised of sub-wavelength spherical particles.

13. The method of claim 12 wherein the sub-wavelength spherical particles are comprised of at least one metal oxide.

14. The method of claim 13 wherein the at least one metal oxide is comprised of silica.

15. The method of claim 8 further comprising strengthening the substrate by ion-exchange before, after, or both before and after, applying the monolayer of nanoparticulates to the at least one transiently softened surface of surface of the substrate.
